(19) United States
(12) Patent Application Publication
(10) Pub. No.: US 2009/0257096 A1
(43) Pub. Date: Oct. 15, 2009

(54) Apparatus With Display For Converting Photographs Into Digital Data

(75) Inventor: Chun Chieh Hsu, Chung Ho City (TW)

Correspondence Address: NEAL, GERBER, & EISENBERG, SUITE 1700, 2 NORTH LASALLE STREET, CHICAGO, IL, 60602, US

(73) Assignee: CRS ELECTRONIC CO., LTD, Hsichi (TW)

(21) Appl. No.: 12/324,080

(22) Filed: Nov. 26, 2008

Related U.S. Application Data
(63) Continuation-in-part of application No. 12/081,045, filed on Apr. 10, 2008.

(51) Int. Cl. H04N 1/00

(52) U.S. Cl. 358/401

(57) ABSTRACT

A photo conversion device that includes an upper shell, a lower shell, and a digital camera assembly, which is positioned within an enclosed space created by the combination of the upper shell and the lower shell. The digital camera assembly further includes a camera lens and, an image sensor for capturing images from photographs and converting the images into digital data capable of being stored by a general purpose computing device or memory device. A display and memory may also be included to allow users to view the images and to allow the photo conversion device to operate on a stand-alone basis.

### CROSS REFERENCE TO RELATED APPLICATION

This application is a continuation-in-part of U.S. patent application Ser. No. 12/081,045 filed on Jan. 14, 2008, which is incorporated herein by reference in its entirety.

### FIELD OF THE INVENTION

This invention relates generally to devices for electronically storing photographed images as digital data. More specifically, the present invention uses standard digital image capturing technology to convert photographs into digital images.

### BACKGROUND OF THE INVENTION

In the past, traditional cameras captured images by using film negatives or film positives and then users printed those images as photographs. By using the film positives or film negatives, copies of the images captured on the film could be reproduced as photographs. If the film was lost, however, users were only left with the printed photograph. With the advent of digital photography and the desire to enhance the ability to reproduce and store existing photographs, many users now prefer to store photographed images electronically. Digital images are easier to store and are not as susceptible as hard copies of photographs to damage from being exposed to common elements. One solution for these problems has been for users to convert existing photographs into digital images. To meet this desire, conversion devices using existing CRT scanning technology have been used.

### SUMMARY OF THE INVENTION

A photo conversion device that includes an upper shell, a lower shell, and a digital camera assembly, which is positioned within an enclosed space created by the combination of the upper shell and the lower shell. The digital camera assembly further includes a camera lens and, an image sensor for capturing images from photographs and converting the images into digital data capable of being stored by a general purpose computing device or memory device. A display and memory may also be included to allow users to view the images and to allow the photo conversion device to operate on a stand-alone basis.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a perspective view of a photo conversion device.

FIG. 2 is an exploded view of the photo conversion device shown in FIG. 1.

FIG. 3 is a more detailed exploded view of the photo conversion device shown in FIG. 1.

FIG. 4 is a sectional view of the photo conversion device shown in FIG. 1.

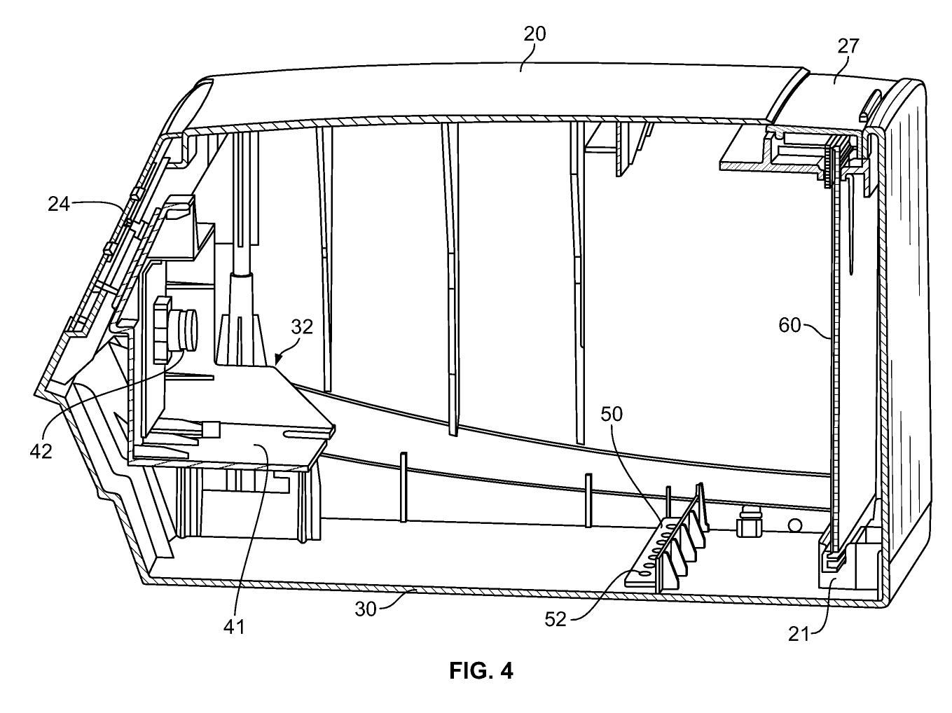

FIG. 5 is a perspective view of an alternative embodiment of a photo conversion device that includes a display.

### DETAILED DESCRIPTION OF THE PREFERRED EMBODIMENT

While several embodiments of the present invention are shown in the drawings and described in detail, the present disclosure should be considered as an exemplification of the principles of the invention and is not intended to limit the invention to the embodiments so illustrated.

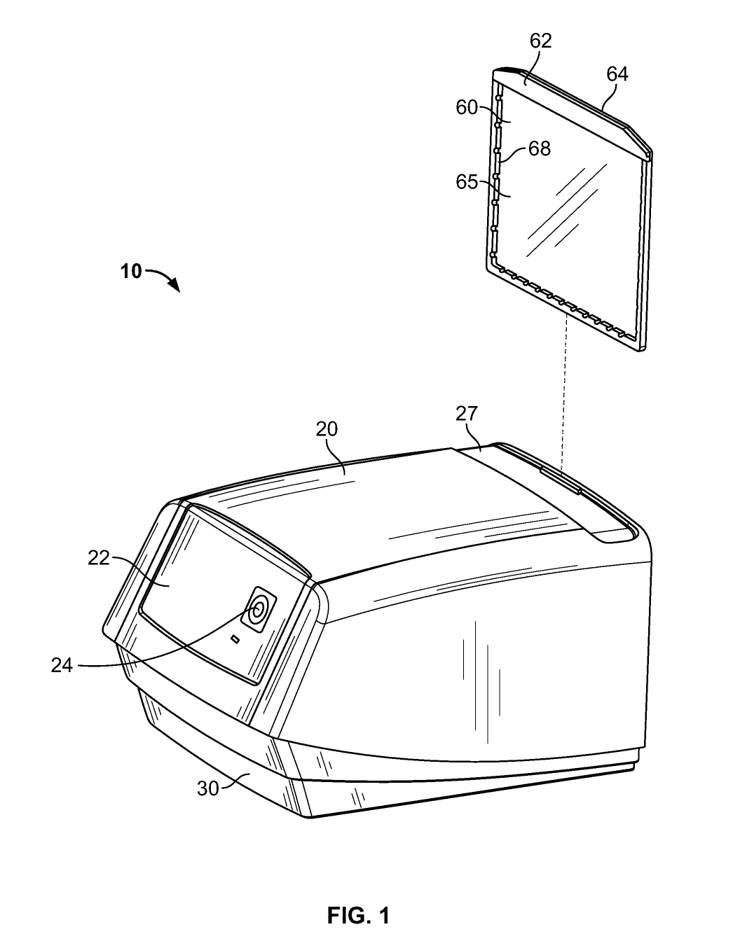

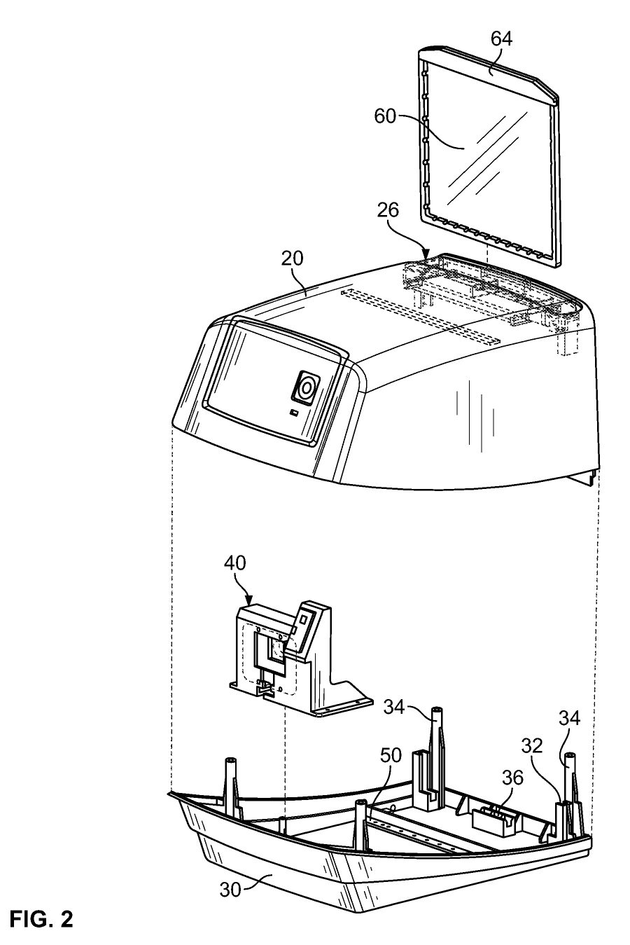

As shown in FIGS. 1 and 2, the present invention is a photo conversion device 10 for converting existing photographs into digital data. The photo conversion device 10 is comprised of an upper shell 20 and a lower shell 30. The combination of the upper shell 20 and the lower shell 30 form an enclosed space, which houses a digital camera assembly 40 for electronically capturing and converting images contained on photographs and a LED assembly plate 50 for illuminating the photograph when it is displaced within the photo conversion device 10. To allow photographs to be inserted within the photo conversion device for digitization, the photo conversion device 10 may include an opening for receiving a photo clamp 60.

As shown in FIG. 1, the photo clamp 60 is comprised of a frame 62 with a slot 64 for receiving a photograph and a back plate 65 for supporting the photograph. In addition, to stabilize and guide the photo as it is inserted into slot 64, a groove 68 may also be formed on the inside of the frame 62 of the photo clamp 60 for supporting the photograph. By inserting the photograph within the groove 68 of the photo clamp 60, the photo clamp 60 will keep the photograph from becoming convex or concave. Controlling the distance between the photograph and the camera lens 42 and the amount of light projected on the photograph is crucial to guaranteeing a consistent and high-quality digitization of the image contained on the photograph. To accommodate photographs of varying sizes, the frame may create differently sized defined spaces. For example, if a larger photograph is being captured, the frame 62 may be a relatively narrow width. On the other hand, if a smaller photograph is being captured, the frame 62 may be formed of a much greater width, which will create a smaller defined space 66. To assist with the insertion and removal of the photo clamp 60 within the opening 26 of the photo conversion device 10, the photo clamp 60 may also include a tab (not shown) located on the top portion of the frame 62. The photo clamp 60 is preferably made of a lightweight, yet sturdy material such as plastic, which may be extruded or blow molded to take the proper form as needed.

Once a photo is positioned within the photo clamp 60, the photo clamp may be inserted into the photo conversion device 10 for digitization/conversion. The photo clamp 60 functions to keep the film flat and also controls the relationship between the photograph to be captured and the digital camera assembly 40, which will be discussed in greater detail below. Although varying distances may be utilized by the photo conversion device 10, the present invention maintains a distance of approximately 215 mm between the camera lens 42 and the photo clamp 60.

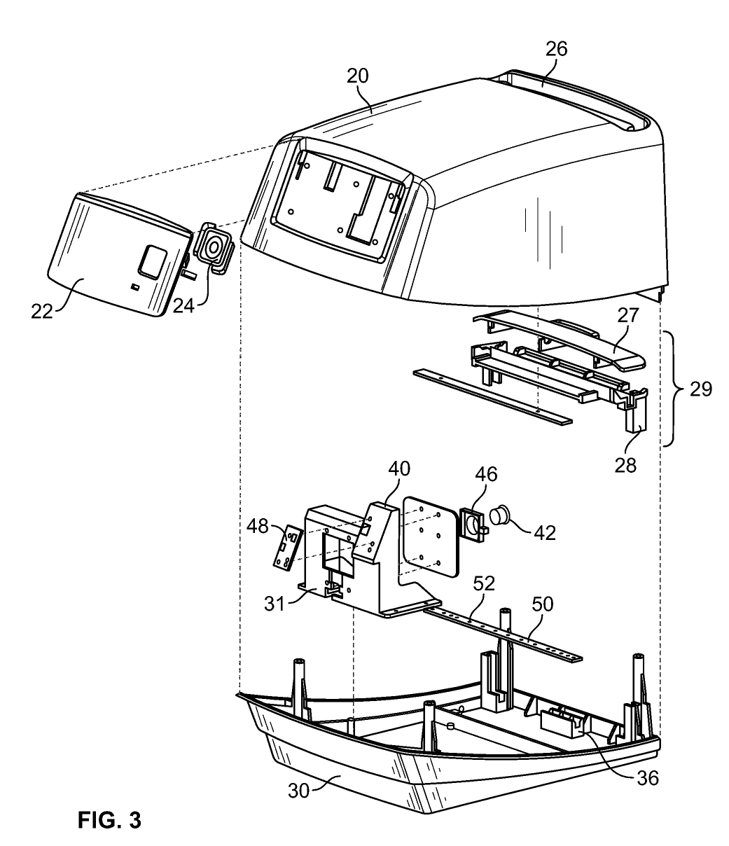

As shown in FIG. 1, an opening 26 is provided on the top surface of the photo conversion device 10 for receiving the photo clamp 60. In addition and as shown in FIGS. 2 and 3, to ensure proper insertion of the photo clamp 60, the upper shell 20 of the photo conversion device 10 may also include upper guides 28 and the lower shell 30 may include lower guides 32. The upper and lower guides 28, 32 act to facilitate the insertion of the photo clamp 60 into the photo conversion device 10 by limiting the horizontal movement of the photo clamp 60 as it is inserted into the photo conversion device 10 and by creating the proper insertion angle for the photo clamp 60. Once the photo clamp 60 is inserted into the photo conversion device 10, the user may depress the button 24 to activate the digital camera assembly and to cause an image to be captured thereby. More specifically, the image is captured by the camera lens 42 and processed by the software or firmware, which may be stored on the image sensor 44, digital signal processor 70, or processor 400. The image may also be uploaded to a general purpose computing device and modified by the user or by software or firmware employed by the general purpose computing device. Once the image has been captured and digitized, the photo clamp 60 may be removed from the photo conversion device 10 and another photograph may be loaded into the photo clamp 60 for digitization. In sum, the present invention may convert photographs into digital data quickly and easily, which allows the user to modify the image displayed on the photograph and to store that image electronically.

The upper guides 28 may also be provided as part of a positioning frame 29. For example, as shown in FIG. 3, positioning frame 29 may be interconnected with upper guides 28. In addition to the positioning frames, the lower shell 30 may also include a clip-fit seat 36 for receiving the photo clamp 60 and removably securing the photo clamp 60 to the lower shell 30. The positioning frame 29 may also include an inlet door 27. The inlet door 27 may be provided to prevent dust and other debris from entering the enclosed space created by the upper shell 20 and lower shell 30. The inlet door 27 may be slidably attached to the position frame 29 and therefore, the user may have to manually slide the inlet door 27 between the open and closed position. The inlet door 27 may also be biased to sit in a closed position. For biasing the inlet door 27 in a closed position, the inlet dust-proof door 27 may include a torsion spring to return the inlet door 27 back to the closed position. The inlet door 27 is positioned at a location immediately below the opening 26 and on the inside portion of the upper shell 20, but other locations may also be selected so long as they create a barrier to dust and debris entering the inside of the photo conversion device 10.

To assist with alignment and assembly of the upper shell 20 and lower shell 30, the lower shell may include a plurality of guideposts 34. As shown in FIG. 3, the guideposts 34 may extend vertically from the lower shell 30 and will assist with positioning the upper shell 20 properly with respect to lower shell 30. It should be obvious to those with skill in the art that the guidepost location and design may be modified without departing from the focus of the present invention. Other alignment means besides the guideposts 34 may also be used without departing from the present information.

To capture images displayed on existing photographs and to convert them into digital data, a digital camera assembly 40 may be provided. The digital camera assembly 40 is further comprised of an assembly frame 41 for supporting a camera lens 42 and an image sensor 44. As shown in FIGS. 2 and 3, the digital camera assembly 40 is positioned within the photo conversion device 10 and may be attached to the lower shell 30. It should be obvious, however, that the digital camera assembly 40 may also be positioned in different locations within the photo conversion device 10 so long as the distance between the digital camera assembly and the photograph are set at the appropriate level and adequate clearance for an LED light source is provided. The digital camera assembly 40 may also include a button 45 that correlates to the button 24 on the photo conversion device 10. Thus, when a user depresses the button 24 on the photo conversion device 10, they are simultaneously pressing the button 45 on the digital camera assembly 40 and activating the digital camera assembly. Activation of the digital camera assembly 40 causes an image to be captured and converted into digital data.

To maintain the quality of the image that is captured by the photo conversion device 10, an LED assembly 50 may be provided. As shown in FIGS. 2 and 3, the LED assembly 50 is attached to the lower shell 30 between the digital camera assembly 40 and the photo clamp 60, which holds the photograph. The LED assembly 50 is further comprised of light emitting diodes 52 (“LEDs”) and illuminates the photograph that is held by the photo clamp for capture by the digital camera assembly 40. The light that is generated by the LED assembly 50 is set to an appropriate level for allowing the digital camera assembly 40 to capture a high-quality image. The LED assembly 50 will include the appropriate number of LEDs 52 and this number may vary depending on the needs of the photo conversion device 10. In addition, the size of the LED assembly 50 and the level of the light emitted from the LEDs 52 may also vary based on the needs of the photo conversion device 10, including the need to reduce the amount of power that is required to operate the photo conversion device 10. Other solid state lighting devices may also be used, such as cold-cathode, fluorescent lamps. Therefore, while it is preferred that the level of light emitted from the LED assembly 50 is set during the production of the photo conversion device 10, the level of light emitted from the LED assembly 50 may also be adjusted manually by the user or adjusted automatically by the photo conversion device 10 during use.

For connecting the internal circuitry associated with the digital camera assembly 40 with a computer and transferring data to the computer through a connector 100, a connecting cable 102 may be provided. The connecting cable 102 may exit the conversion device 10 at the bottom side of the lower shell 30, but it should be obvious to those with skill in the art that the connecting cable 102 may exit the conversion device 10 at various points without departing from the teachings of the present invention.

To cause the conversion device 10 to capture an image from a photograph, a user may depress a button 24 located on the upper shell 20, as shown in FIG. 1. The button 24 may also be positioned at other location on the conversion device 10 so long as it is relatively easy to access. As mentioned above, the button 24 may be further designed to interact with a switch that is located on the underside of the upper or lower shell 20, 30, of the conversion device 10. The interaction between the button 24 and the switch is mechanical in nature, but an electrical or wireless connection between the button 24 and the switch may also be employed. It should be obvious that the button 24 and switch are designed to control the operation of the digital camera assembly 40, and more specifically, the camera lens 42 and image sensor 44 and to initiate the digitization of images displayed on the photograph and captured by the image sensor 44, and that this function is capable of being performed in a multitude of other manners. Thus, the disclosure related thereto should not be viewed as limiting the scope of the present invention.

For receiving images that are displayed on the photograph, the photo conversion device 10 includes camera lens 42. While there are a variety of different types of lenses that are capable of capturing images, the present invention uses a four glass lens. Other types of lenses may also be employed by the photo conversion device 10 without departing from the teachings of this invention and are well-known in the industry.

For capturing images that are received by the camera lens 42 and converting them to a digital signal, an image sensor 44 may be provided. It should be obvious to those with skill in the art that these images are captured as single images versus other methods for capturing images, such as scanning the image on a line-by-line basis. For example, a CMOS sensor may be used as the image sensor 44 and operate in combination with the camera lens 42. Other types of sensors or processing chips may also be used, such as CCD sensors. An important attribute for CMOS sensors is that they have lower power consumption relative to other image sensors. The image sensor 44 may capture images of various resolutions and the resolution level for the image sensor 44 is an important factor. For example, the present invention is designed to include an image sensor 44 that captures images at a resolution of up to 5 mega-pixel and that operates at up to 12 MHz. For a more detailed example of the operating specifications for the image sensor 44 see the sensor data sheet for the MI-5100 CameraChip by Micron. Image sensors that operate faster or at higher resolutions may also work with the present invention. Additionally, it should be obvious that the camera lens 42 and image sensor 44 may be combined into a single unit or module or exist as separate components, as desired.

To process the digital signal that is produced by the image sensor 44 and to convert it into the proper data format, a digital signal processor 70 may also be provided. More specifically, the digital signal processor 70 may receive a digital signal from the image sensor 44 that correlates to the image that is received by the camera lens 42. The digital signal processor 70 may then convert the digital data that is representative of the image displayed on the photograph and received by the camera lens 42 into a JPEG format, although other formats may also be utilized. The digital signal processor 70 also acts as an interface between the image sensor 44 and a general purpose computing device. It is possible that the digital signal processor 70 may also be formed as part of a more general microprocessor, which is defined as any hardware device for executing software, particularly software stored in memory. Therefore, any custom made or commercially available processor, such as a central processing unit (CPU), an auxiliary processor, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation.

To power the photo conversion device 10, the photo conversion device 10 may require 5 V to operate and may be designed to receive DC power. It should be obvious, however, that the conversion device 10 may also be adapted to run on AC power or via batteries. The photo conversion device 10 may also use different components to limit the power consumption of the conversion device 10, such as by using an image sensor 44 or other discrete components that have a low-power requirement.

For transmitting digital images to outside storage devices or a general purpose computing device, the photo conversion device 10 may include a universal serial bus (“USB”) port 90. USB ports are well-known in the industry and are used to connect various electronic devices directly to general purpose computing devices and to facilitate the high speed transfer of information between an electronic device and a computer. The USB port 90 may also be used in combination with the connecting cable 102. Other data ports may also be used to transfer information for the photo conversion device 10 to general purpose computing devices, such as serial, parallel or similar data ports, and improved means for data transfer that may be developed in the future that may also be employed. The conversion device 10 may use any of the other available options for transferring data from the conversion device 10 to a storage device or general purpose computing device.

The data that is representative of the digital image that has been captured by the conversion device 10 may be compressed into a variety of different formats, including as a JPEG, TIFF or RAW, or other similar formats, and transferred to a general purpose computing device via the USB port 90. General purpose computing devices may include personal computers (PC; IBM-compatible, Apple-compatible, or otherwise), personal digital assistants, cell phones, workstations, minicomputers, or mainframe computers. In addition, as is well-know in the industry, each of these general purpose computing devices may include electronic memory, a display, an input device and an output device or port. The above-referenced list of general purpose computing devices should not be viewed as being exhaustive or limiting in any way. The conversion device 10 may also employ existing technology to communicate with general purpose computing devices via wireless means. Wireless data communication is also well-know in the industry and it should be evident that any existing or future developed technology for accomplishing wireless communication could be utilized.

To transfer digital data from the image sensor 44 to a general purpose computer via the USB port, the conversion device 10 may also include bridge processor 72. Bridge processors are devices that operates as a data link between one device and another and whose function is to connect and pass packets of information between the two devices.

To convert, view and store images that are converted into digital data, the photo conversion device 10 may also include memory 300. The memory 300 may comprise read only memory (ROM), a hard disk drive for reading from and writing to a hard disk, a magnetic disk drive for reading from and writing to a magnetic disk, and/or an optical disk drive for reading from and writing to a removable optical disk or any other suitable data storage device. The hard disk drive, magnetic disk drive, and optical disk drive may be connected to processing unit via a system bus and a hard disk drive interface, a magnetic disk drive interface, or an optical disk drive interface, respectively, or other suitable data interface.

The drives and their associated computer-readable media provide a means of non-volatile storage for the computer executable instructions and any other data structures, program modules, databases, arrays, digital data, etc. utilized during the operation of the photo conversion device 10. Other non-volatile storage may also be employed, and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Memory 300 may also have a distributed architecture where various components are situated remote from one another, but are still accessed by a processor 400, and may be removable, such as removable memory cards, flash memory cards, SD cards, etc. These removable memory devices are well-known in the art and are produced in a number of different formats, sizes and memory levels. The type of memory, the level of memory, and the integration of the memory do not have any bearing on the scope of the present invention and any devices that store data may be used in connection therewith. Processor 400 may be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

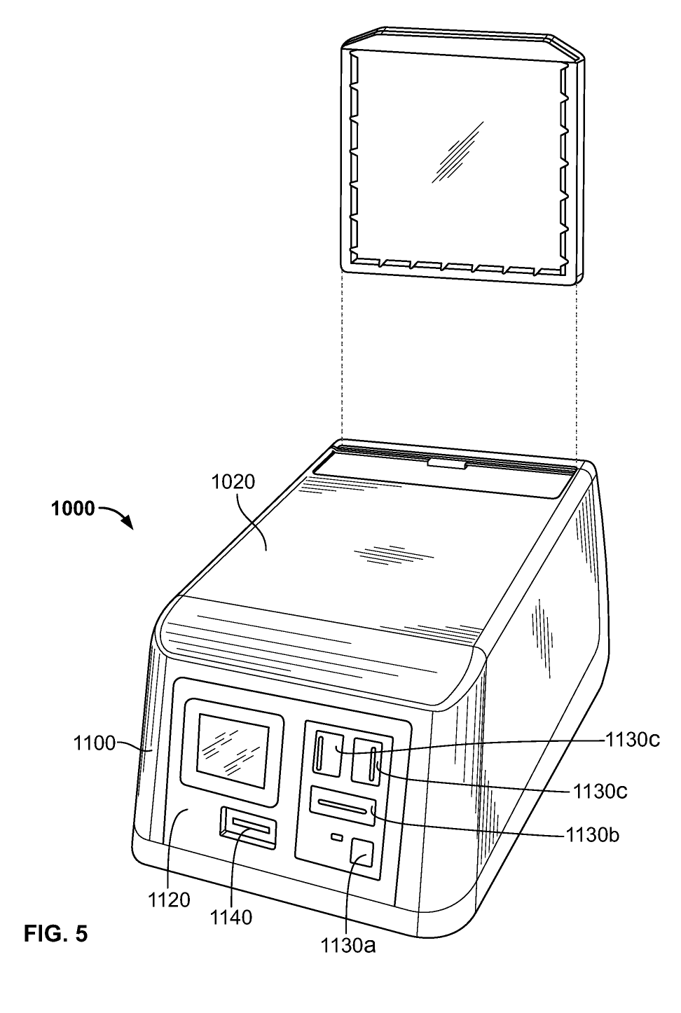

As shown in FIG. 5, another embodiment of the photo conversion device 1000 may also be provided that operates on a stand alone basis. To operate independently of a general computing device, the photo conversion device 1000 may also include a display 1100, memory 1200 and a processing unit 1300. The display 1100 may be comprised of existing technology, such as a Thin Film Transistor display (“TFT”), a cathode ray tube (“CRT”), a liquid crystal display (“LCD”), a flat screen monitor, a touch screen monitor or similar means for displaying textual and graphical data to a user, or it may incorporate later developed technology that achieves this same purpose. The display 1100 may also require a video adapter and display memory, but this technology is well-known in the industry and various manners from enabling a display 1100 may be incorporate without departing from the teachings of this disclosure. Although this embodiment of the present invention is discussed in terms of operating on a stand alone basis, it may also operate in connection with a general purpose computing device.

The processing unit 1300 is a hardware device for executing software, particularly software stored in memory 1200. Processing unit 1300 can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 402 may also represent a distributed processing architecture such as, but not limited to, SQL, Smalltalk, APL, KLisp, Snobol, Developer 200, MUMPS/Magic.

For example, the alternative embodiment shown in FIG. 5 may include a color TFT display 1100 that accesses images that are stored on memory 1200, such as a removable SD card. The display 1100 may be any standard size, but ideally the display 1100 will be between 1.5″ to 3.5″. In fact, in this embodiment of the present invention, the display 1100 is a 2.36″ screen and has dimensions of 55.2(W) mm×47.55(H) mm×2.9(D) mm.

As shown in FIG. 5, the display 1100 may be included as part of a panel 1120 located on an upper shell 1020 of the photo conversion device 1000. The panel 1120 may include various buttons 1130 for controlling access to the images, actuating the conversion process, or turning the device 1000 on and off. The buttons 1130 may include a menu button 1130a, a start button 1130b, forward and backward buttons 1130c, and any other buttons that may assist the user in capturing, storing and editing images.

The panel 1120 may also include a slot 1140 for receiving SD memory cards for storing digital images. Although not shown, it is also possible that the display 1100 may be attached to the upper shell 1030 as a flip screen and therefore, it may be capable of assuming an open and a closed position. To achieve the open and closed positions, the display 1100 may be attached to the photo conversion device by a hinge. The conversion device may also be activated based on the position of the display; in other words, when the display is in the open position, the conversion device 1000 will power up and when the display is in the closed position, the conversion device 1000 will power down.

The resolution of the display 1100 may be between 480 (RGB) and 234 megapixels, but the present embodiment is designed to display up to 5 megapixels of resolution. It is also possible for the display 1100 to be attached to different portions of the photo conversion device 1000, so long as it is easily accessible, and for the display 1100 to swivel or pivot to allow for easier viewing by the user.

The display 1100 may function to display previews of the captured images, to display captured images that are stored on the memory 1200, or to allow users to edit captured images. The display 1100 will be compatible with JPEG images, but it may also display images in other formats that are known in the industry. The conversion device 1000 may also include an external video output 1150 for displaying captured images on an external display or television. For printing captured images, the photo converter 1000 may also include a printer port or serial port 1250 for direct connection to an external printer. The photo converter 1000 may be powered by an AC/DC adapter, via a USB cable that is connected to a independent computer, or batteries.

To allow users to edit captured images via the display 1100, the display 1100 may include a menu. The menu may include options for navigating through the library of photos that are stored on the memory 1200, editing captured images, changing user or display settings on the conversion device 1000, or performing other functions that are standard in the digital image and photo processing industry, such as cropping the image or reducing “red eye”. To add the above-referenced functionality and to assist with file format conversion, additional firmware or software may be added. Firmware and software to accomplish these functions is well-known in the industry.

The firmware or software that is executed by the processing unit 1300 may include one or more separate programs. The separate programs comprise ordered listings of executable instructions for implementing logical functions. The software may also operate in accordance with a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system essentially controls the execution of computer programs and provides scheduling, input-output control, file and data management, memory management, and communication control and related services.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

We claim:

1. A photo conversion device for converting a photographed image into digital data, including:
an upper shell;
a lower shell for cooperating with the upper shell to create an enclosed space;
a camera lens and image sensor attached to the lower shell of the body and positioned within the enclosed space;
an opening formed on the upper shell for receiving the photograph; and
a photo clamp for holding the photograph, the photo clamp capable of being inserted into the opening;
a LED assembly mounted on the lower shell and positioned between the camera lens and the photo clamp, wherein the LED assembly illuminates the photograph;
a display for depicting images that are captured by the camera lens; and
wherein the image is converted to digital data in a single step and without scanning the image on a line-by-line basis.

2. The device claimed in claim 1, wherein the camera lens may be attached to a printed circuit board assembly that includes a connecting cable to be extended out, the outer end of the connecting cable further including a connector to connect the device with a computer to upload the digital data for modification and storage.

3. The device claimed in claim 2, wherein the connector is a universal serial bus (“USB”) connection.

4. The device claimed in claim 1, wherein the opening includes an inlet door for preventing dust and debris from entering the enclosed space formed by the photo conversion device.

5. The device claimed in claim 1, wherein the photo conversion device is a stand-alone device and does not require connection to any other device-in order to convert photographs into digital data.

6. The device claimed in claim 1, wherein the display is a thin film transistor (“TFT”) display.

7. The device claimed in claim 6, wherein the display is compatible with JPEG images.

8. The device claimed in claim 6, wherein the display is mounted on the top of the upper shell.

9. The device claimed in claim 6, wherein the display may be positioned in either an open position or a closed position and wherein when the device is in the open position, the device is powered up and when the device is in the closed position, the device powers down.

10. The device claimed in claim 1, wherein the photo conversion device further includes memory for storing images that are captured by the camera lens.

11. The device claimed in claim 10, wherein the memory is a removable SD card.

12. A photo conversion device for converting a photographed image into digital data, including:
an upper shell;
a lower shell for cooperating with the upper shell to create an enclosed space;
a camera lens and image sensor attached to the lower shell of the body and positioned within the enclosed space;
an opening formed on the upper shell for receiving the photograph; and
a photo clamp for holding the photograph, the photo clamp capable of being inserted into the opening;
a LED assembly mounted on the lower shell and positioned between the camera lens and the photo clamp, wherein the LED assembly illuminates the photograph; and
wherein the image is converted to digital data in a single step and without scanning the image on a line-by-line basis.

13. The device claimed in claim 12, wherein the camera lens may be attached to a printed circuit board assembly that includes a connecting cable to be extended out, the outer end of the connecting cable further including a connector to connect the device with a computer to upload the digital data for modification and storage.

14. The device claimed in claim 13, wherein the connector is a universal serial bus (“USB”) connection.

15. The device claimed in claim 12, wherein the photo conversion device further includes a display for depicting images that are captured by the camera lens;

16. The device claimed in claim 15, wherein the display is a thin film transistor (“TFT”) display.

17. The device claimed in claim 15, wherein the display is mounted on the top of the upper shell.

18. The device claimed in claim 15, wherein the display may be positioned in either an open position or a closed position and wherein when the device is in the open position, the device is powered up and when the device is in the closed position, the device powers down.

19. The device claimed in claim 12, wherein the photo conversion device further includes memory for storing images that are captured by the camera lens.

20. The device claimed in claim 19, wherein the memory is a removable SD card.
